(19) United States
(12) Patent Application Publication
(10) Pub. No.: US 2004/0053535 A1
(43) Pub. Date: Mar. 18, 2004

(54) Multi-function socket combination

(76) Inventor: Shao Gong Liu, Taipei (TW)

Correspondence Address: CHARLES E. BAXLEY, 5th Floor, 59 John Street, New York, NY, 10038, US

(21) Appl. No.: 10/242,812

(22) Filed: Sep. 16, 2002

(51) Int. Cl. H01R 25/00; H01R 27/02; H01R 31/00; H01R 33/88; H01R 33/90; H01R 33/92; H01R 33/94

(52) U.S. Cl. 439/638

(57) ABSTRACT

A socket device includes one or more sockets disposed in a housing and coupled to AC electric power source via a control switch. An AC/DC converter is coupled to the switch or to the sockets, for converting the AC current to DC current, and includes one or more sockets for outputting the DC current, and for allowing the DC electric facilities to be easily energized by the DC electric power with the further sockets. One or more switches may further be coupled to the sockets, for controlling the sockets. One or more couplers may be used for coupling to telecommunication systems.

### BACKGROUND OF THE INVENTION

1. Field of the Invention

The present invention relates to a socket, and more particularly to a socket combination for providing both alternative current (AC) and direct current (DC) power supplies.

2. Description of the Prior Art

Typical sockets are coupled to the electric power sources of the family housings, for supplying or providing the AC currents to the electric facilities, and for energizing the electric facilities. The typical sockets may not supply the DC currents, such that an additional adapter is required to be plugged to the socket and is then coupled to the other electric facilities, and for energizing the other electric facilities that are energized by DC current.

In addition, the typical sockets may not be used for plugging or for coupling the telecommunication lines with each other.

The present invention has arisen to mitigate and/or obviate the afore-described disadvantages of the conventional sockets.

### SUMMARY OF THE INVENTION

The primary objective of the present invention is to provide a socket combination for providing both alternative current (AC) and direct current (DC) power supplies.

The other objective of the present invention is to provide a socket combination for providing the sockets and/or plugs for telecommunication lines or systems.

In accordance with one aspect of the invention, there is provided a socket combination comprising a housing, at least one first socket disposed in the housing, and coupled to electric power source for receiving AC current therefrom, a first switch coupled to the first socket for controlling the first socket, and an AC/DC converter coupled to the first switch, for converting the AC current to DC current, and including at least one second socket for outputting the DC current, and for allowing the DC electric facilities to be easily energized by the DC electric power with the second socket.

A second switch may further be provided and coupled to the first socket, for controlling the first socket. A further switch may be provided and coupled to the converter and the second socket, for controlling the second socket and the converter.

One or more telecommunicating couplers may further be provided and disposed in the housing, for coupling to telecommunication systems, such as the telecommunicating network systems or the like.

Further objectives and advantages of the present invention will become apparent from a careful reading of a detailed description provided hereinbelow, with appropriate reference to accompanying drawings.

### BRIEF DESCRIPTION OF THE DRAWINGS

FIG. 1 is a perspective view of a socket combination in accordance with the present invention;

FIG. 2 is an exploded view of the socket combination; and

FIG. 3 is a schematic view illustrating the circuit of the socket combination.

### DETAILED DESCRIPTION OF THE PREFERRED EMBODIMENT

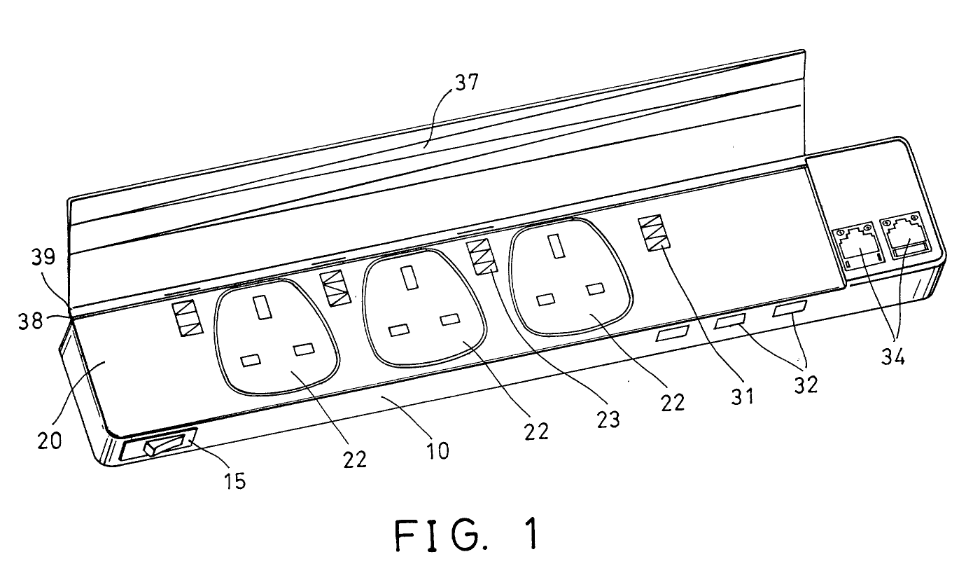

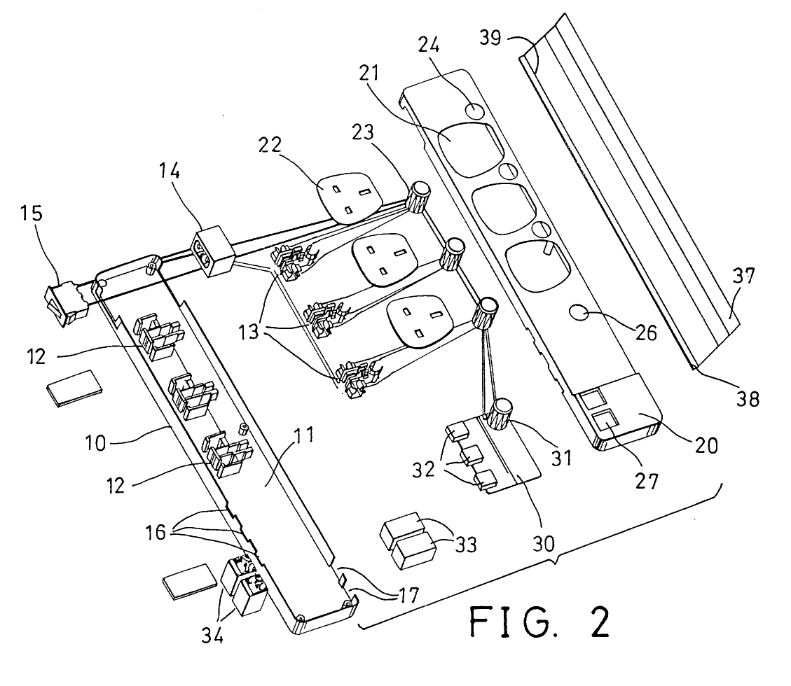

Referring to the drawings, and initially to FIGS. 1 and 2, a socket combination in accordance with the present invention comprises a housing 11 including a chamber 11 formed therein, and including one or more seats 12 disposed in the chamber 11 thereof for receiving one or more pairs or sets of conductor members 13 therein.

A socket or a coupler 14 is disposed in the housing 10, and coupled to the electric power sources of the family housings, with such as plugs or couplers and electric wires, for receiving the AC current power source therefrom. A switch 15 is coupled to the coupler 14, for switching on and off or for controlling the electric power to the socket combination.

A face panel 20 is secured on top of the housing 10 with such as fasteners, latches, adhesive materials, or by welding processes, and includes one or more openings 21 formed therein for receiving one or more sockets 22 or socket caps therein respectively. The sockets 22 or the socket caps are disposed above the seats 12 and the conductors 13 respectively for forming the typical sockets 22 to which the electric facilities may be coupled thereto.

One or more knobs or switches 23 may be coupled to the conductors 13 of the sockets 22 respectively for switching on and off the electric power to the conductors 13 of the sockets 22 respectively. The face panel 20 includes one or more orifices 24 formed therein for receiving the switches 23 respectively, and for allowing the switches 23 to be operated or actuated by the users, in order to control the electric power to the conductors 13 of the sockets 22 respectively.

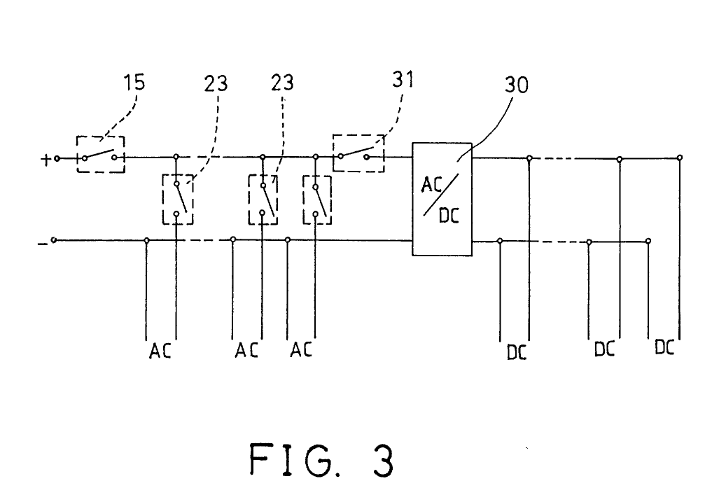

The socket combination further includes an AC/DC converter 30 (FIGS. 2, 3) disposed in the chamber 11 of the housing 10, and coupled to the coupler 14 and/or to the switch 15 and/or the sockets 22, for converting the AC current to DC current. The converter 30 includes one or more couplers or sockets 32 provided thereon or coupled thereto for outputting the DC currents. The sockets 32 may be engaged in the apertures 16 of the housing 10.

A knob or a switch 31 is further provided and coupled to the converter 30, for switching on and off the electric power to the converter 30. The switch 31 may be extended outwardly through an aperture 26 of the face panel 20, for allowing the switch 31 to be operated or actuated by the users, in order to switch on and off the converter 30. The sockets 32 may include different output voltages, such as 3V, 4.5V, 5V, 6V, 9V, 12V, etc., for supplying different DC voltages to different electric facilities.

The socket combination further includes one or more sockets or couplers 33 disposed in the chamber 11 of the housing 10, for coupling to the telephone or telecommunication systems, such as the telecommunication networks; and one or more further sockets or couplers 34 disposed in the chamber 11 of the housing 10, and coupled to the couplers 33, for telephone or telecommunication purposes, or for receiving or calling telephones. The couplers 33 may be engaged in the orifices 17 of the housing 10, and the other couplers 34 may be engaged in the apertures 27 of the face panel 20.

In operation, as shown in FIG. 1, various kinds of the computer facilities may be coupled to the AC sockets 22, and/or the DC sockets 32, without providing further converters or the like. In addition, the computer facilities may also be directly coupled to the telecommunication network systems with the couplers 33, 34 for easily communicating with the telecommunication network systems. The socket combination is thus excellent for being used with the computer systems or facilities.

As shown in FIGS. 1 and 2, a cover 37 may further be provided and directly and pivotally coupled to the housing 10 or the face panel 20 with a live hinge 39. Alternatively, the cover 37 may include a longitudinal flange 38 engaged in a corresponding channel (not shown) of the housing 10 or of the face panel 20, and/or with adhesive materials or by welding processes, for allowing the cover 37 to be rotated relative to the housing 10 or the face panel 20 about the live hinge 39, and for allowing the cover 37 to cover the sockets 22, the switches 23, 31, and the couplers 34.

Accordingly, the socket combination in accordance with the present invention may be used for providing both alternative current (AC) and direct current (DC) power supplies, and for providing the sockets and/or plugs for telecommunication lines or systems.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A socket combination comprising:
a housing,
at least one first socket disposed in said housing, and coupled to electric power source for receiving AC current therefrom,
a first switch coupled to said at least one first socket for controlling said at least one first socket, and
an AC/DC converter coupled to said first switch, for converting the AC current to DC current, and including at least one second socket for outputting the DC current.

2. The socket combination according to claim 1 further comprising a second switch coupled to said at least one first socket, for controlling said at least one first socket.

3. The socket combination according to claim 1 further comprising a second switch coupled to said converter and said at least one second socket, for controlling said at least one second socket and said converter.

4. The socket combination according to claim 1 further comprising a first and a second telecommunicating couplers disposed in said housing, for coupling to telecommunication systems.
